(19) United States
(12) Patent Application Publication
(10) Pub. No.: US 2010/0195905 A1
(43) Pub. Date: Aug. 5, 2010

(54) METHOD OF SETTING CONTRAST IN DIGITAL IMAGE PROCESSING, AND AN ARRANGEMENT FOR THIS PURPOSE

(75) Inventor: Roland Richter, Munchen (DE)

Correspondence Address: DLA PIPER LLP (US), 2000 UNIVERSITY AVENUE, EAST PALO ALTO, CA, 94303, US

(73) Assignee: TRIDENT MICROSYSTEMS (FAR EAST) LTD., Grand Dayman (KY)

(21) Appl. No.: 12/063,060

(22) PCT Filed: Jul. 31, 2006
(86) PCT No.: PCT/IB2006/052606

§ 371 Date: Feb. 6, 2008

(30) Foreign Application Priority Data
Aug. 8, 2005 (EP) 05107292.4

(51) Int. Cl. G06K 9/36

(52) U.S. Cl. 382/167; 382/169

(57) ABSTRACT

The invention relates to a method of setting contrast in digital image processing in which a brightness distribution in the form of a histogram is produced from image pixels and the histogram is revised with the help of transfer functions, and in which a linear increase in contrast takes place in a region of the image.

The invention relates to a method of setting contrast in digital image processing in which a brightness distribution in the form of a histogram is produced from image pixels and the histogram is revised with the help of transfer functions, and to an arrangement of suitable design.

From the technology of digital image processing, it is known that a digital image picked up in a known fashion is composed of individual picture elements or pixels, with each pixel having assigned to it both a brightness, or what is referred to as a gray shade, and also, in the case of a colored digital image, a tristimulus value, i.e. a color. An image picked up in this way may either be stored immediately in a suitable storage medium or may be reproduced on any desired display device such as, for example, an LCD screen.

It is known in this case that the display device may have only a limited so-called dynamic range, i.e. that the maximum brightness or gray shade that is able to be reproduced by the display device at a pixel usually differs to only a limited degree from the minimum gray shade or brightness that can be shown. If however the image that is shown on such a display device is one that has been picked up digitally and that contains wide differences in contrast, such as, for example, a shot of a person or an object taken against light coming from behind the person or object in which there are extreme contrasts between light and dark, then the differences in brightness concerned cannot be exactly reproduced on the display device. This applies both to the reproduction of single images and to the reproduction of a sequence of images picked up digitally in the form of a video image.

In digital image processing, it is known for the individual image pixels to be read electronically, in the form of a brightness distribution, into a histogram to simplify the further electronic processing of the image information. What this means is that a fixed number of pixels is assigned to each cell in the histogram, with both the position of the pixel in the image and also a brightness level and, where required, information on the color concerned in the given case being read in.

To allow an adaptation to be made to the capabilities of a display device, it is known for the histogram, or rather the values which have been read into it, to be revised, in order in particular to adapt the maximum differences in contrast in the histogram to the capabilities of the display device. This is done for example by applying to the input signal a non-linear color-code assigning function by which given intervals in the brightness distribution are made larger and others are made smaller in order to correct the histogram.

From the publication entitled: λ-Enhancement: Contrast Adaptation Based on Optimization of Image Fuzziness, H. R. Tizhoosh, G. Krell, B. Michaelis, Otto-von-Guericke-University Magdeburg, 1998, it is known for an improvement in contrast to be obtained with the help of mathematical functions based on fuzzy logic. For this purpose, the histogram is revised mathematically with transfer functions to achieve improved image reproduction in this way.

US 2005/0035974 A1 also describes a histogram that is known per se and such as is used in electronic image processing. In this case the mathematical revision of the histogram is performed with the help of a fixed number of transfer functions, which number remains constant in the course of the adaptation process. In this case the transfer functions are decided on before the histogram is revised, which means that adaptation to different image contents is not possible.

US 2003/0152266 A1 describes a known histogram, and in this case too the brightness values of image pixels whose brightness would be too low for appropriate reproduction on the display device are raised by mathematical methods to a minimum value to enable them to in fact be reproduced.

U.S. Pat. No. 6,658,399 B1 discloses a similar method in which brightness values of image pixels are likewise set to a minimum value, fuzzy logic being used in this case too.

Something that has to be considered a disadvantage of the known methods of digital image processing is that particularly where images contain wide differences in contrast, such as happens for example in shots of the natural world taken both by photography and video, these images can be reproduced only in an inadequate way by the known methods or devices because a blanket increase is made in low brightnesses, i.e. low gray shades, which means that the background of an image for example may appear to be uniformly light when this is not what is desired. Also, the methods call for considerable computing capacity, which means that the arrangements used have to be elaborate and costly in design.

It is an object of the invention to specify a method of setting contrast in digital image processing that is suitable in particular for enabling natural images such as persons or shots of landscapes to be reproduced with an increased image quality. An appropriate arrangement for this purpose is also to be provided.

These objects are achieved by virtue of the features specified in claims 1 and 5.

The key concept underlying the invention is that a linear increase in contrast between the individual pixels or picture elements is made in only one region of the image, i.e. in only a section of the entire area that is shot. What this means is that, in the selected region of the image, the gray values and/or the tristimulus values are acquired in the histogram and are corrected linearly in the appropriate way, in such a way that the correction corresponds to the maximum resolution in contrast that is possible on the associated display device. What is achieved in this way is that, in the section or region that is selected of the digital shot, use is made of the maximum contrast available, and in this way the reproduction of the maximum possible information becomes possible on, for example, an LCD display.

For this purpose, the pixels belonging to the region selected that have the lowest and highest brightness value are detected, and all the pixels' values lying therebetween are adapted linearly in the appropriate way in order to assign the minimum brightness able to be shown by the display device to the lowest brightness value and the maximum brightness able to be shown by it to the highest brightness value.

It is also within the scope of the invention for the region that is revised linearly in this way either to be laid down by a user himself, in the case for example of digital image processing on screen, or for the region having the greatest density of information to be selected automatically. Fuzzy logic processes may also be used for this purpose in a known fashion. This may, in particular, be done by collecting a brightness distribution for the image, distributed in a fuzzy manner, in a histogram, in order in this way to obtain an assignment of the brightness and/or tristimulus values to the image. From this assignment function, the region having the highest density of information can then be determined automatically by assuming that a large change in the tristimulus or brightness values in a small space represents a high density of information.

What is meant by the terms “histogram” or “filtered histogram” in what follows is not a histogram as understood in the prior art described above as the filtering processes according to the invention not only assigns the measured data to fixed classes but also classifies it into different classes with the help of a fuzzy assigning function.

The advantage of the invention lies in the fact that an automatic adaptation is performed of any desired images to the capabilities of the display device, because the differences in contrast that are produced are always only ones that the display device is actually able to show with sufficiently good quality. Also, the method calls for a substantially lower computing capacity.

It goes without saying that the method steps described above may be implemented in an appropriate arrangement by either hardware and/or software means and may for example be incorporated in the form of a microprocessor in a digital camera.

Advantageous embodiments of the invention are characterized in the dependent claims.

What is achieved by the non-linear compression specified in claims 2 and 6 of the color distribution outside the selected region is that the values of any image pixels that there may possibly be that are outside the limits of the brightnesses or colors that are able to be shown are changed in such a way that they can nevertheless be shown in acceptable quality on the display or image-reproducing device. In particular, the regions that are non-linearly compressed are only those regions that contain less information than the region selected, which means that the user does not suffer any disadvantages due to losses of information when viewing the complete image.

The transfer function with which the histogram is revised in a manner known per se is, as claimed in claims 3 and 7, preferably not laid down or preset prior to the image processing proper but is only determined from the histogram. For this purpose, the region that contains the highest density of information, and whose contrast is to be increased linearly in what follows, is first determined from the digital image. By reference to the values determined in this way for brightness values and colors, that transfer function is selected with which the best adaptation will be possible to the capabilities of the display device. This can be done automatically in an arrangement of suitable design, by for example simulation using different transfer functions.

It is of course possible, as claimed in claims 4 and 8, for a user of the method or of the suitably designed arrangement to himself be able to lay down the region in which he wishes there to be a linear increase in contrast, even though this may be a region that does not have a maximum density of information. In the case of digital image processing on screen, he may for example select the region in question with the help of a movable pointer or cursor. It would be conceivable, in the case of a portrait shot, for this to be the head region in the shot, to ensure that the head region was accurately reproduced.

These and other aspects of the invention are apparent from and will be elucidated with reference to the embodiments described hereinafter.

In the drawings:

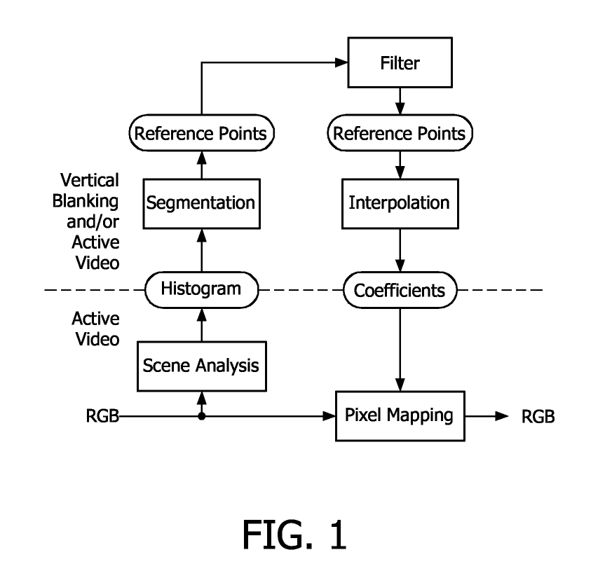

FIG. 1 shows a schematic block diagram of the method,

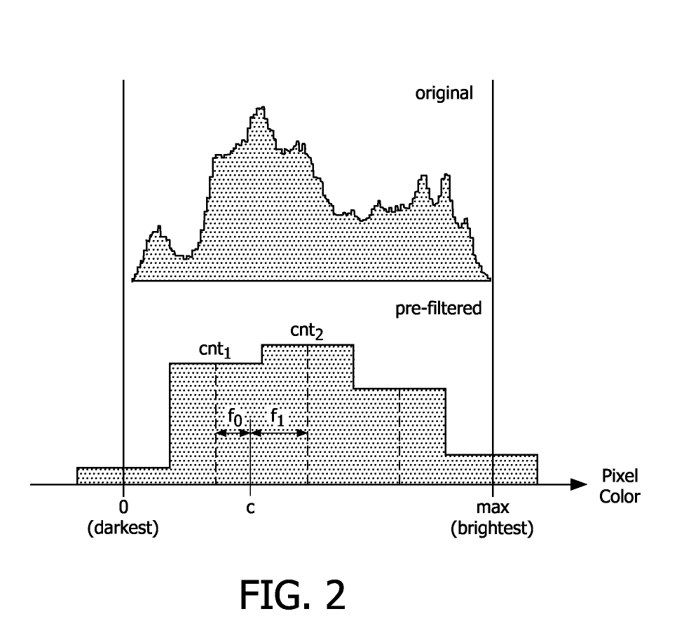

FIG. 2 shows a prefiltered histogram,

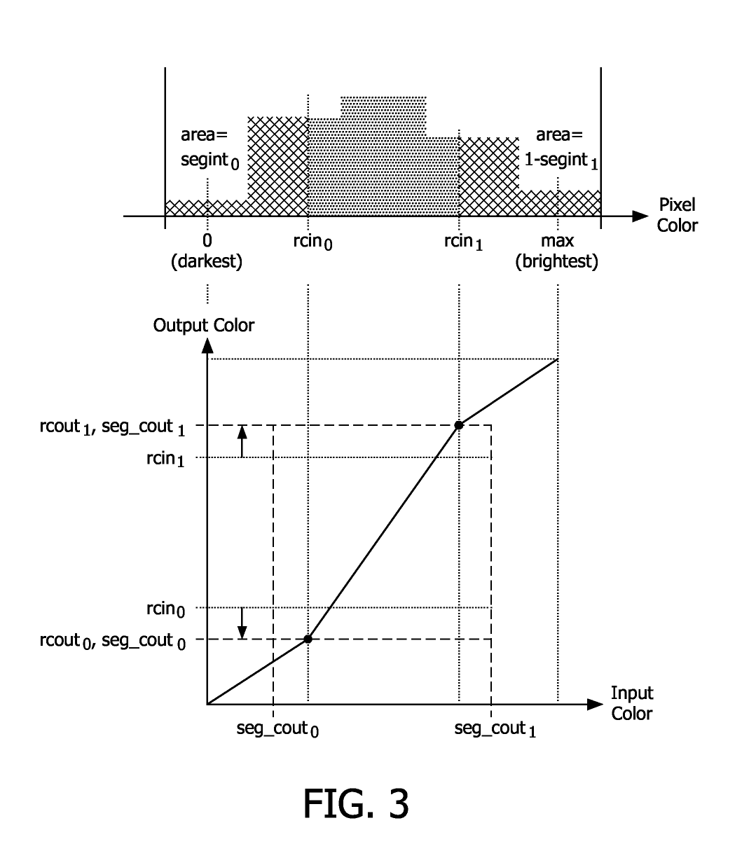

FIG. 3 shows the distribution of the data, and

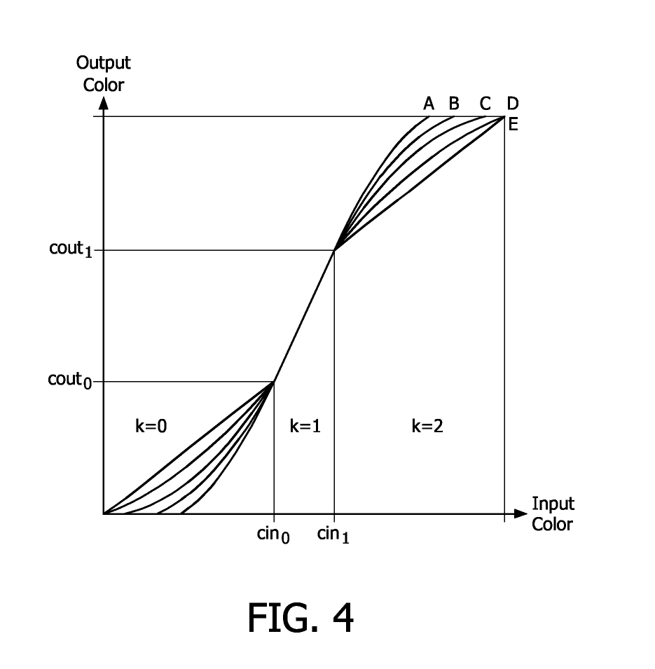

FIG. 4 shows the clipping.

From the schematic block diagram in FIG. 1 can be seen the basic procedure followed in the image processing, with data interfaces being shown as oval boxes and processing operations by data processing devices being shown as rectangular boxes.

The processing of the pixels takes place in real time during the flow of data which arrives as a data stream representing a video image. What are used for the processing are a histogram unit for analyzing the scene shown and a pixel control unit for the assignment of color. Algorithmic calculations have to be performed for each pixel. In contrast to this, the processing of the parameters ideally takes place only during the vertical blanking. An assignment function for the red, green and blue (RGB) color codes for the next data block or field is to be defined in this case by using the statistics of the previous one. The period covered by the process may also be extended to the next active data-processing block or even longer, so long as the result is available in sufficiently good time to obtain temporal coherence between the block of transmitted data that is analyzed and the one that is corrected. The algorithmic calculations are to be performed only once per block or field of transmitted data. This allows successive treatment by hardware and/or software means. The segmentation unit establishes the region of the color codes that covers the major part of the complete color distribution, and determines a reasonable target range, to which said major part is assigned for the purpose of improving contrast. The result is processed using a set of two reference points in the color space for the assigning function and is passed through a filter. An interpolation unit lays down the clipping characteristics at the top and bottom ends of the transfer or assigning function and converts these characteristics into coefficients for the color assignment. These values are brought up to the latest state at the beginning of an active block of transmitted data. The minimum delay in the correction is therefore a single block or field of transmitted data.

As an alternative to this layout, the invention may also be applied to a system having a buffer store, with the analysis and change of the color distribution taking place in the same block of transmitted data. In this way the processing of the pixels is able to be performed in a more flexible way when the implementation is wholly or partly by software means.

For the image analysis, pseudonormalized color codes c are used for all the following formulas. What this means is that cₘᵢₙ equals 0 (black) and cₘₐₓ equals 2^{-PIXBITS} (red, green or blue), where PIXBITS is the number of bits, usually eight or ten, which is used for the coding of a single color channel.

BINBITS is the number of most significant color code bits that are used for the addressing of a histogram counter. A suitable value that will be used in what follows is two. This value controls the width of the pre-filter and the size of the histogram data interface. The actual number of cell counters n_{cnt} works out as:

Normalized=2BINBITS and n_{cnt}norm.+1

It should be borne in mind in this case that the original width of the distribution is enlarged by the pre-filter, as can be seen from FIG. 2. Each color component of an RGB pixel is counted separately into the same histogram. A special code c is distributed between two adjacent cell counters cntⱼ and cntⱼ₊₁, with the proportion f that is contributed being a linear function of the distance from the center of the cell:

cₙ=c* norm. j=|cₙ|

f₀j=cₙ−j f₁=1−f₀

For a digital implementation, it is only the most significant bits of c that are used, such as j for example, and the least significant ones such as f₀. Finally, the counters are set to a high level in the way specified below:

cntⱼ=cntⱼ+f₁ cntⱼ₊₁=cntⱼ₊₁+f₀

It should be borne in mind in this case that the advantage of using this method of filtering not only lies in the considerable reduction in the number of counter values but also that temporal interruptions that may result from a fixed cell classification combined with a simple increase of the counters when there are small changes in the input signal are avoided. Another important algorithm that is required is the one for the spatial low-pass filter characteristic that lessens the reaction of the downstream dividing unit when there are very small brightness distributions.

For better implementation, f_{1,0} may, in addition, be weighted in accordance with the proportional brightness of the associated component. This is of greater importance for the green channel than for the blue one.

The division determines a range of color codes that is focused on the maximum of the color distribution cntj and that assists with the increase in contrast. It is defined by two statistical parameters segin_{0,1} that, as can be seen in FIG. 3, specify the normalized weight of distribution to the left of the region boundary rcin_{0,1}:

cntₜₒₜ=Σcntᵢ where j=0 to n_{cnt}

segᵢ*cntₜₒₜ=∫cnt_{|c*norm.+0.5|}dc ᵢ=0,1 from −∞ to rcinⱼ

The center region has a linear increasing factor applied to it to increase contrast, whereas the outer regions are compressed using a soft-clipping algorithm that is used in the downstream interpolation unit.

Because of the pre-filtering of the histogram, this method may result, for very dark or very light color distributions, in rcin values that are outside the range of color codes able to be shown [cₘᵢₙ, cₘₐₓ]. This is a desired and advantageous effect and it is performed by the clamping of rcin in this region. If rcin₀=cₘᵢₙ, then the lower soft-clipping region is virtually completely suppressed and the beginning of the linear center region is moved to the origin. Hence, in the case of a very dark image, no non-linear distortion effects occur in the center of the distribution. Much the same applies to very light images and their upper region. It should also be borne in mine that with this method no temporal discontinuities are created such as may occur within the range of colors able to be shown when threshold methods are used.

The degree of improvement in the contrast is controlled by various parameters. segadapt is a dynamic parameter and can be set by the user at values of between zero (no image) and one (maximum improvement in contrast). All the other parameters should be adapted statistically and to suit the particular use. These parameters are segcout_{0,1}, which gives the target color code for the assignment of rcin_{0,1} for segadapt=1. The usual settings are:

segcout₀=segint₀ segout₁=1−segint₁

to allow the histogram to be corrected easily. A further parameter is seglimit, which limits the change in brightness that a pixel undergoes. The desired assignment results rcout_{0,1} are calculated as follows:

s₀=+1 s₁=−1

dcout₁=sᵢ*(rcinᵢ−segcoutᵢ)*segadapt

rcoutᵢ=rcinᵢ−s1*clamp (0, dcoutᵢ, seglimit)

It should be borne in mind in this case that the setting of the minimum for dcout to zero stops the center region from being compressed and the outer regions from being too heavily boosted if color distributions are being processed that are concentrated on dark and/or light colors.

Finally, the two reference points rcinᵢ and rcoutᵢ for the color assigning function are passed on to the next sub-unit. To suppress flickering in statistical regions of a sequence of images whose color does not change over the course of time, an IIR filter for temporal damping is applied to the co-ordinates of the reference points to delay the response signal. filtstrength and filtthresh are statistical parameters in this case:

(dcinᵢ over dcoutᵢ)=(rcinᵢ over rcoutᵢ)−(cin; over coutᵢ)ₚᵣₑᵥ

(cinᵢ over coutᵢ)=(rcinᵢ over rcoutᵢ) if |dcin_{0,1}| or |dcout_{0,1}|>filtthresh

otherwise(cinᵢ over coutᵢ)=(cinᵢ over dcoutᵢ)ₚᵣₑᵥ+(dcinᵢ over dcoutᵢ)*filtstrength

The threshold value filtthresh may be laid down in such a way that changes in image that prevent filtering are found. The two reference points for the color assignment function that are fed to the next unit are, in the end, cinᵢ and coutᵢ.

The final assignment of the pixel codes is performed with a polynomial of variable order. For the sake of simplicity, the polynomial is confined to the first and second orders.

The interpolation unit generates polynomial coefficients that form an assigning function that extends through the two reference points, that assigns these two points to one another linearly, with which parametrizable clipping is possible in the outer regions and with which no gaps or discontinuities occur even when the accuracy of calculation is low.

For each region having an index k, a set of three coefficients pc0, pc1 and pc2 is generated. The same coefficients are applied to the red, green and blue channels. The calculation that is finally performed on each pixel in each channel works out as follows:

dcin_{0,1}=cin_{0,1}−c

(k,i)=(0,0) if dcin₀≧0(2,1) if dcinᵢ≦0 and otherwise (1,0)

c′=pc0ₖ+dcinᵢ*pc1ₖ+dcinᵢ²*pc2ₖ

where c′ is the new color code. The coefficients are multiplied by the value dcin rather than the color code c to prevent there from being gaps in the curve at the reference points due to the limited accuracy of the coefficients or multipliers.

For the linear center region (k=1), the coefficients work out as follows:

pc0₁=cout₀ pc2₁=0

pc₁=(cout₀−cout₁)/(cin₁−cin₀)

The behavior of the outer regions can be controlled by a set of statistical parameters. In what follows, only the boundary conditions will be elucidated by way of example.

The following conditions are common to all the following methods of interpolation:

c′(cₘᵢₙ)=cmin c′(cin₀)=cout₀ c′(cin₁)=cout₁ c′(cₘₐₓ)=cₘₐₓ

In the simplest case, a linear soft clip may be applied, of the kind that is shown in FIG. 4 by curve E, in which pc2_{0,2} is set as equal to zero. In this way, a saving is made of second-order multipliers in the processing of the pixels and the calculation of the parameters is considerably simplified, although when there are slow increases in color there may be a visible curvature at cin_{0,1}.

The clipping behavior may preferably be implemented by slight changes in the assigning function at cin with, at the same time, the clipping in the outer regions being sharp. What is used for this purpose is a set of statistical parameters ipolclip_{0,1} that limit the gradient for the transfer function to c_{min,max}. In what follows it will be merely the upper region that is elucidated, the lower region being calculated in a corresponding way.

An additional degree of freedom is produced with a second-order coefficient. What is therefore required at cin₁ is a soft transition, with the gradient needing to be the same for the center and upper regions:

dc′/dc(cin₁)=−pc1₁

The result is compared with the ipolclip parameters:

dc′/dc(cₘₐₓ)<ipolclip₁

If this condition is not met, the coefficients are re-calculated using the formula

dc′/dc(cinₘₐₓ)=ipolclip₁

which formula gives a continuously differentiatable transition at cin₁.

What this means is that a positive ipolclip value gives the flatness of the curve that approaches fully saturated tristimulus values, a hard clip being avoided. In contrast to this, a negative value allows partial saturation for the lightest color codes and enlarges the increase in contrast. For the majority of images, for which a moderate improvement in contrast is obtained, both a soft transition and soft clipping are possible at the same time. Only when there are large increases in contrast do the marked curvatures at the reference points, see curves C and D in FIG. 4, and the sometimes severe clipping, see curves A and B in FIG. 4, have an effect.

It will be clear to the person skilled in the art that the invention may be applied to any kind of digital image processing, in particular for a matrix display. A change in contrast set by the user is also possible. Particularly when there is back-lighting, as in LCD television sets for example, this back-lighting can be acted on dynamically with the invention. When dark images are being shown on the screen the back-lighting is reduced and at the same time the contrast of the darker shades of color is increased and the lighter shades of color are compressed. In simple terms, what this means is that to a viewer a black appears even blacker whereas a shade of gray remains unchanged and a light or white shade of color is dimmed.

1. A method of setting contrast in digital image processing comprising a method in which a brightness distribution in the form of a histogram is produced from image pixels and the histogram is revised with the help of transfer functions, characterized in that a linear increase in contrast takes place in a region of the image.

2. A method as claimed in claim 1, characterized in that a non-linear compression of the color distribution takes place outside said region of the image.

3. A method as claimed in claim 1, characterized in that the transfer function used is determined from the histogram.

4. A method as claimed in claim 1, characterized in that the region of the image is preset.

5. An arrangement for improving contrast in a digital image processing system, comprising an arrangement so designed that a brightness distribution in the form of a histogram can be produced from image pixels and the histogram can be revised with the help of transfer functions, characterized in that a linear increase in contrast can be performed in a region of the image.

6. An arrangement as claimed in claim 5, characterized in that a non-linear compression of the color distribution can be performed outside the region of the image.

7. An arrangement as claimed in claim 5, characterized in that the transfer function can be determined from the histogram.

8. An arrangement as claimed in claim 5, characterized in that the region of the image can be preset.
